(19) United States
(12) Patent Application Publication
(10) Pub. No.: US 2010/0326880 A1
(43) Pub. Date: Dec. 30, 2010

(54) Hydrocarbon Conversion Process Additive and Related Processes

(75) Inventors: Sudhakar Chakka, Naperville, IL (US); Bang Xu, Naperville, IL (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 12/491,726

(22) Filed: Jun. 25, 2009

(51) Int. Cl. C10G 1/00; C07G 1/00; C10G 11/00; C10G 9/00

(52) U.S. Cl. 208/14; 530/500; 530/502; 208/113; 208/131; 208/46; 208/125; 208/428

(57) ABSTRACT

This invention relates to a hydrocarbon conversion process additive and related processes, such as upgrading a heavy hydrocarbon material and making sponge coke. The hydrocarbon conversion process additive works with thermal processes, catalytic processes, or thermal-catalytic processes. The hydrocarbon process conversion additive includes lignin or macromolecular substructures of lignin like para-coumaryl alcohol, coniferyl alcohol, or sinapyl alcohol.

### BACKGROUND

1. Technical Field

This invention relates to a hydrocarbon conversion process additive and related processes, such as upgrading heavy hydrocarbon material and/or making sponge coke.

2. Discussion of Related Art

Modern refineries include many units and/or process blocks, such as crude distillation units, hydrotreating units, fluidized catalytic cracking units, residue fluidized catalytic cracking units, delayed coking units, continuous coking units, hydrocracking units, visbreaking units, and/or the like.

However, even with the above technology in modern refineries, there remains a need and a desire to for hydrocarbon conversion processes that enhance a liquid product yield, increase API (American Petroleum Institute) gravity of a liquid product, lower a coke yield, or change a coke product morphology.

### SUMMARY

This invention relates to a hydrocarbon conversion process additive and related processes, such as upgrading heavy hydrocarbon material and/or making sponge coke. The additives and processes of this invention can enhance a liquid product yield, increase API gravity of a liquid product, lower a coke yield, and/or change a coke product morphology.

According to a first embodiment, this invention includes a hydrocarbon conversion process additive for thermal processes, catalytic processes, and/or thermal-catalytic processes. The additive includes lignin and/or macromolecular substructures of lignin including para-coumaryl alcohol, coniferyl alcohol, and/or sinapyl alcohol.

According to a second embodiment, this invention includes a process for upgrading a heavy hydrocarbon material and/or making sponge coke. The process includes the step of delivering an additive to a process feedstock and/or into a process, and the step of conducting a hydrocarbon upgrading process.

According to a third embodiment, this invention includes a refining process. The process includes the step of mixing a lignin based additive with a hydrocarbon stream, and the step of thermally processing, chemically processing, and/or thermal-catalytically processing the hydrocarbon stream.

According to a fourth embodiment, this invention includes a petroleum coke made by any of the process additives, processes for upgrading heavy hydrocarbon materials and making sponge coke, and/or refining processes described herein.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 shows a schematic view of a delayed coking process, according to one embodiment; and

FIG. 2 shows a partial view of a lignin molecule, according to one embodiment;

FIG. 3 shows a photomicrograph of sponge coke, according to one embodiment;

FIG. 4 shows a photomicrograph of shot coke; and

FIG. 5 shows a photomicrograph of the shot coke of FIG. 4 at a different magnification.

### DETAILED DESCRIPTION

This invention relates to a hydrocarbon conversion process additive and related processes, such as upgrading heavy hydrocarbon material and/or making sponge coke. This invention can include additives for controlling the morphology of coke produced in delayed cokers, specifically for producing predominantly sponge coke from delayed cokers. The present invention also can relate to an improved delayed coking process where additives are injected into the coke drum at low concentration to shift a coke morphology to sponge coke. The coke morphology shifting additives of the present invention can include lignin, lignin derivatives, and/or the like. Additional benefits of the additives can include increased liquid yield, reduced coke formation, lighter liquid products, and/or the like.

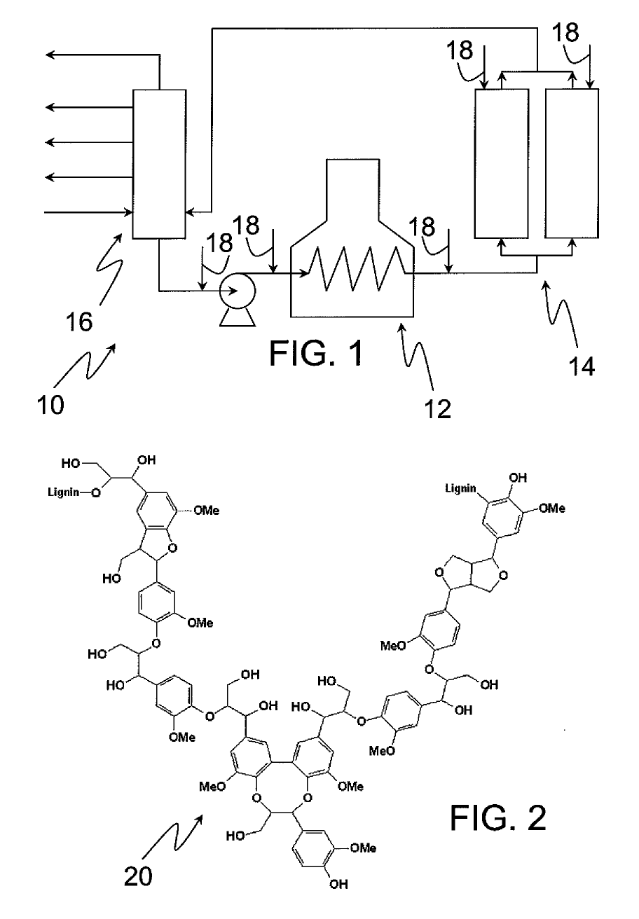

FIG. 1 shows a schematic view of a delayed coking process 10, according to one embodiment. The delayed coking process 10 includes a furnace 12 and coke drums 14. The delayed coking process 10 also includes a fractionator 16. The delayed coking process 10 includes one or more injection points 18, such as for additive addition.

FIG. 2 shows a partial view of a lignin molecule 20, according to one embodiment. The lignin molecule 20 can be used as an additive to hydrocarbon conversion processes.

According to one embodiment, this invention can include a hydrocarbon conversion process additive for thermal processes, catalytic processes, thermal-catalytic processes, and/or the like. The additive can include lignin and/or macromolecular substructures of lignin including para-coumaryl alcohol, coniferyl alcohol, and/or sinapyl alcohol.

Hydrocarbon broadly refers to any suitable compound containing predominantly and/or mostly carbon and hydrogen, such as may be derived from crude oil, petroleum, natural gas, coal, tar sands, shale, bitumen, and/or the like.

Thermal broadly refers to relating to and/or caused by heat and/or temperature. Thermal processes may operate at any suitable temperature, such as at least about 100 degrees Celsius, between about ambient conditions and about 1,000 degrees Celsius, between about 250 degrees Celsius and about 750 degrees Celsius, between about 350 degrees Celsius and about 525 degrees Celsius, and/or the like.

Catalytic broadly refers to relating to and/or caused by a catalyst. Catalyst broadly refers to a substance and/or material for modification of a rate of a chemical reaction, where a catalyst material remains unchanged chemically at completion of a reaction. Desirably, but not necessarily, a catalyst lowers an activation energy of reaction, such as to increase a rate of reaction. Catalysts may be heterogeneous, homogenous, and/or the like. Catalysts may be supported (on a carrier material), unsupported, and/or the like. Catalysts may contain metals, nonmetals, elements, compounds, any other suitable material, and/or the like.

Thermal-catalytic broadly refers to relating to and/or caused at least in part by both a thermal process and/or a catalytic process.

Conversion process broadly refers to any suitable method or steps to change and/or alter characteristics and/or features of molecules and/or compounds. Conversion processes generally, but not necessarily, include at least one chemical reaction, such as breaking long molecules into shorter molecules. Conversion process may also include separation and/or fractionation, such as distillation.

Process broadly refers to a series of actions, steps, operations and/or the like, such as conducing to an end and/or a goal. A process may be discrete, batch, semi-batch, semi-continuous, continuous, and/or the like.

Additive broadly refers to elements, compounds, mixtures, and/or the like, to affect a change and/or a difference in a material, a process and/or the like.

Lignin broadly refers to a generally amorphous polymer that can be related to cellulose and that can provide rigidity to cells. Together with cellulose, lignin can form woody cell walls of plants and/or a cementing material between cell walls. According to one embodiment, lignin suitable as an additive can be in any suitable form, such as a solid, a liquid, a suspension, a solution, and/or the like. The lignin can be any suitable type and/or from any suitable source, such as kraft lignin, klason lignin, acid-soluble lignin, acid-insoluble lignin, hardwood lignin, softwood lignin, paper pulping lignin, alcell lignin, pyrolytic lignin, steam exploded lignin, agricultural material lignin, genetically-modified lignin, oxidized lignin, derivatized lignin, modified lignin, and/or the like.

The lignin and/or macromolecular substructures of lignin may have any suitable average molecular weight, such as between about 300 atomic mass units to about 1,000,000 atomic mass units, between about 1,000 atomic mass units to about 100,000 atomic mass units, between about 5,000 atomic mass units to about 50,000 atomic mass units, and/or the like.

The lignin and/or macromolecular substructures of lignin may be in any suitable form, such as a solid, a powder, a granule, a pellet, a solution, a suspension, a slurry, an emulsion, and/or the like.

Optionally and/or additionally, the additive may include macromolecular substructures of lignin, such as para-coumaryl alcohol, coniferyl alcohol, sinapyl alcohol, and/or the like. Combinations of lignin and macromolecular substructures of lignin are within the scope of the invention.

According to one embodiment, the lignin and/or macromolecular substructures of lignin may include polyphenolic material. Polyphenolic material can contain more than one phenol group. Phenol groups can have an unsaturated 6 carbon aromatic ring with a hydroxyl group attached, for example.

Without being bound by theory of operation, lignin and lignin based polymers can decompose or breakdown under thermal, catalytic, and/or thermal-catalytic conditions to form and/or make molecules and/or molecular fragments with phenolic groups. Molecules with phenolic groups can inhibit and/or slow free radical reactions, such as free radical reactions occurring in hydrocarbon conversion processes. For example and according to what is believed, shot coke formation can occur in a delayed coking process, if asphaltene moieties in the oil rapidly and/or quickly react with one another. Slowing down the fast reaction between asphaltene moieties may prevent shot coke formation and may result in sponge coke formation.

According to one embodiment, the hydrocarbon conversion process may include delayed coking, continuous coking, Fluidcoking™ (Fluidcoking is a trademark of ExxonMobil of Irving, Tex., U.S.A.), Flexicoking™ (Flexicoking is a trademark of ExxonMobil of Irving, Tex., U.S.A.), fluidized catalytic cracking, residue fluidized catalytic cracking, thermal catalytic cracking, thermal cracking, hydrocracking, visbreaking, hydrovisbreaking, catalytic hydrovisbreaking, coal liquefaction, and/or the like. Desirably, but not necessarily, the hydrocarbon conversion process reduces a molecular size or an average molecular weight of a feedstock.

The additive may have any suitable form, such as a solid, a pelletized material, a granulated material, a solution, an emulsion, a slurry, a suspension, and/or the like. Suitable carrier materials may include, but are not limited to, hydrocarbons of any suitable boiling range, oxygenated hydrocarbons, solvents, water, and/or the like. The additive may be combined and/or mixed in any suitable amount, such as less than about 50 percent of the feed stream, less than about 25 percent of the feed stream, between about 0.01 percent and about 20 percent of the feed stream, between about 0.1 percent and about 5 percent of the feed stream, and/or the like on a mass basis.

The additive may include any suitable additional molecules and/or compounds, such as cracking catalysts, free radical initiators, free radical inhibitors, anti-flocculants, flocculants, hydrogen transfer catalysts, metal oxides, sulfides, organometallic complexes, dispersants, water, hydrogen, carbon monoxide, high molecular weight polymers with oxygen functional groups, metal overbases, metal dispersions, high surface area solids, Lewis acids, oil soluble organometallic compounds of various metals, hydrogen, metal powders, sulfur, sulfur compounds, phosphoric acid, coal, carbon materials, carbonaceous materials, and/or the like.

According to one embodiment, this invention may include petroleum coke made with any of the additives disclosed herein. The petroleum coke may have any suitable characteristics. The petroleum coke may include shot coke, needle coke, sponge coke, anode grade coke, and/or the like. The petroleum coke of this invention may be useful for production of anodes used in aluminum smelting and/or refining of bauxite ore.

Sponge coke broadly refers to generally isotropic and/or amorphous cokes, such as may include a visibly porous structure. The petroleum coke may contain any suitable amount of sponge coke, such as at least about 30 percent, at least about 40 percent, at least about 50 percent, at least about 60 percent, at least about 70 percent, at least about 80 percent, at least about 90 percent, and/or the like on a mass basis.

According to one embodiment, this invention may include a process for upgrading a heavy hydrocarbon material and/or making sponge coke. The process may include the step of delivering an additive to a process feedstock and/or into a process, and the step of conducting a hydrocarbon upgrading process.

Upgrading broadly refers to any suitable step and/or action to improve and/or increase a desirability of and/or a value of a material and/or a stream. Upgrading processes can include thermal processes, catalytic processes, thermal-catalytic processes, and/or the like.

Heavy hydrocarbon broadly refers to fractions and/or materials having an at least relatively thick viscosity and/or a low API gravity, such as less than about 20 degrees of API gravity, less than about 10 degrees of API gravity, less than about 0 degrees of API gravity and/or the like. Suitable sources of heavy hydrocarbon material may include crude oil, crude atmospheric distillation bottoms, vacuum distillation bottoms, residue oils, bitumen, decant oils, and/or the like.

Delivering an additive to a process feedstock and/or into a process may include any suitable step and/or equipment, such as injecting, inducting, pumping, pouring, conveying, pneumatically conveying, mixing, combining, agitating, forming a slurry, forming an emulsion, forming a suspension, forming a solution, and/or the like. The additive can be delivered in any suitable location into the heavy hydrocarbon upgrading process, such as before entering a furnace, after entering a furnace, before catalyst addition, after catalyst addition, mixing at an entrance of a coke drum, mixing within a coke drum, delivered to a top of coke drum, before a regenerator, after a regenerator, and/or the like.

Conducting a hydrocarbon upgrading process may include any suitable step and/or equipment. The upgrading process can occur in a delayed coking unit, a continuous coking unit, a Flexicoking™ unit, a Fluidcoking™ unit, and/or the like.

Feedstock broadly refers to a raw material and/or input supplied to a machine, process, processing plant, and/or the like.

According to one embodiment, the process may include the step of adding an asphaltene dispersant as a coadditive. Any suitable asphaltene dispersant may be used, such as those available from Champion Technologies Incorporated (Houston, Tex., U.S.A.), Nalco Company (Sugarland, Tex., U.S.A.), Baker-Petrolite (Baker Hughes Incorporated, Sugarland, Tex., U.S.A.), and Kurita Group (Tokyo, Japan). Asphaltene dispersants can operate at any suitable temperature, such as remaining at least partially stable at temperatures of at least about 200 degrees Celsius or higher while in hydrocarbons mixtures.

Desirably, the additive may include lignin, macromolecular substructures of lignin, and/or the like. Macromolecular substructures of lignin may include para-coumaryl alcohol, coniferyl alcohol, sinapyl alcohol, and/or the like.

The additive may be added in any sufficient and/or suitable amount and/or quantity, such as between about 1 parts per million on a mass basis and about 50,000 parts per million on a mass basis in a feedstock, between about between about 10 parts per million on a mass basis and about 20,000 parts per million on a mass basis in a feedstock, less than about 5,000 parts per million on a mass basis in a feedstock, and/or the like.

The process may produce and/or make any suitable type and/or quantity of coke, such as petroleum coke with at least about 60 percent sponge coke, at least about 70 percent sponge coke, at least about 80 percent sponge coke, at least about 90 percent sponge coke, and/or the like on a mass basis.

The process with the additive may have any desirable affect and/or outcome, such as enhanced liquid product yield, lowered or reduced coke yield, changed coke product morphology, increased API gravity of a liquid product (made lighter), and/or the like. Several of the desirable affects may result in an increase in the coker unit capacity, such as to allow and/or provide for increasing a feed rate to the coker unit. Additionally and for refineries that may be coker capacity limited, ultimately additional crude oil capacity may be achieved using the processes and/or additives of this invention. Optionally, increased coke capacity can allow and/or provide for processing a heavier crude oil and/or crude slate (mixture), such as may provide increased refining margins and/or reduced raw material costs. The additive may also improve unit operability and/or reliability, such as reducing coking and/or fouling of furnace tubes. Less fouling can allow longer run times between maintenance outages, for example.

Enhanced liquid product may include an increase of any suitable amount, such as between at least about 0.01 weight percent and about 10 weight percent, at least about 0.1 weight percent, and/or the like than a process without the additive.

Lowered or reduced coke (solid) yield may include a decrease of any suitable amount (less coke generally causes more of higher value products, like liquid products), such as between about 0.01 weight percent and about 10 weight percent, at least about 0.1 weight percent, and/or the like than a process without the additive.

Changed coke morphology may include making a different type and/or amount of a coke, such as reducing shot coke content, increasing sponge coke content, increasing needle coke content, and/or the like. According to one embodiment, the process additive may form at least about 5 percent more sponge coke, at least about 10 percent more sponge coke, at least about 20 percent more sponge coke, at least about 30 percent more sponge coke, and/or the like on a weight basis than a process without the additive.

Increased API gravity of a liquid product (made lighter) may include an increase of at least about 2 degrees of API gravity, an increase of at least about 5 degrees of API gravity, and increase of at least about 10 degrees of API gravity, and/or the like than a process without the additive.

Optionally and/or additionally, the process may include steam and/or water injection at a suitable location, such as before a furnace, after a furnace, before a coke drum, at a top of a coke drum, and/or the like. The steam and/or water injection may be at any suitable amount, such as zero percent, between about zero percent and about 25 percent, between about 0.1 percent and about 5 percent, at least about 0.5 percent, and/or the like of the feedstock on a mass basis.

According to one embodiment, this invention may include petroleum coke made with any of the processes for upgrading a heavy hydrocarbon material and/or making sponge coke disclosed herein. The petroleum coke may have any suitable characteristics.

According to one embodiment, this invention may include a refining process including the step of mixing a lignin based additive with a hydrocarbon stream, and the step of thermally processing, chemically processing, and/or thermal-catalytically processing the hydrocarbon stream. Refining processes may occur within a battery limits of a refinery, outside the battery limits of a refinery, and/or the like. Outside battery limits may include in an oil field, in a bitumen field, in a natural gas field, on a platform in deep water, in an intermediate shipping location, in an intermediate storage location, and/or the like.

The refining process may occur in any suitable unit and/or equipment, such as a fluidized catalytic cracker, a residue fluidized catalytic cracker, a thermal catalytic cracker, a visbreaker, a hydrocracker, a residue hydrocracker, a coal liquefaction unit, a delayed coker, a continuous coker, and/or the like.

### EXAMPLES

Experiments were conducted in a delayed coking pilot plant to demonstrate coking additives. The pilot plant had a furnace and a coke drum. The coke drum was an about 190 centimeter (75 inch) stainless steel tube with an about 7.6 centimeter (3 inch) internal diameter. Typical repeatability of product yields from the delayed coking batches in this pilot plant run within about 0.5 weight percent for both coke (solid) and liquid products.

A feedstock was prepared and circulated through the furnace and into the coke drum for each example described below. Each example was run for about 4 hours before the coke drum was steam stripped for an hour at process temperature and cooled under slight vacuum for at least about 8 hours before opening.

Gaseous products (coker off-gases) were analyzed on-line by gas chromatography. Total liquid products from each of the coking pilot plant runs were combined and analyzed by gas chromatograph simulated distillation to quantify yields of various boiling range products from the coking process. As used below, gasoline has boiling point range of between about 28 degrees Celsius (82 degrees Fahrenheit) and about 221 degrees Celsius (430 degrees Fahrenheit). Diesel has a boiling point range of between about 221 degrees Celsius (430 degrees Fahrenheit) and about 343 degrees Celsius (650 degrees Fahrenheit). Gas oil has a boiling point range of greater than about 343 degrees Celsius (650 degrees Fahrenheit).

The coke was analyzed by elemental analysis. The coke was also analyzed for texture by an optical microscope. Morphology of the coke collected at various heights of the coke drum was visually analyzed. A total weight of the coke was measured by weighing the coke drum before and after a pilot plant run with the coke in it.

### Example 1

A feedstock of about 554+ degree Celsius (1030+ degree Fahrenheit) residue fractionated from a Canadian oil sands bitumen was used. The feedstock was thoroughly mixed with 1 weight percent water in a heated pressurized feed container. A commercially available asphaltene dispersant known as product SR 1347 from Dorf Ketal Chemicals Limited Liability Company (Stafford, Tex., U.S.A.) was also blended with the feed at about 25 parts per million by mass. The properties of the feedstock were:

API gravity=0.0 degrees;

kinematic viscosity at 150 degrees Celsius 4,000 centistokes;

sulfur content=5.88 weight percent;

nitrogen content=6,867 part per million mass;

vanadium content=440 parts per million mass;

nickel content=173 parts per million mass;

iron content=17 parts per million mass;

aromatics=58 weight percent;

paraffins=23 weight percent;

naphthenes=19 weight percent;

acidity (total acid number—TAN)=1.35 milligrams KOH per gram; and

Conradson carbon residue (CCR)=25.9 percent.

The delayed coking pilot unit process conditions for Example 1 were:

coke drum pressure=1.4 bar gauge;

furnace outlet temperature=496 degrees Celsius;

feed rate=3,600 grams per hour; and

approximately 40 grams/hour of steam was injected into the furnace tube continuously to minimize fouling.

A lignin based chemical was used as an additive for Example 1. The additive was obtained from Sigma-Aldrich Company, St. Louis, Mo., U.S.A. The additive was Sigma-Aldrich Catalog No. 470996, lignin, alkali, carboxylated. Properties of the additive were:

number average molecular weight=about 16,000 atomic mass units;

weight average molecular weight=about 175,000 atomic mass units;

carboxylation=16 weight percent;

methoxy groups=6 weight percent;

total impurities=1 weight percent sulfur (nonsulfate);

pH=8 as 3 weight percent solution in water; and

solubility=water soluble.

The additive system utilized a 7.6 liter (2 gallon) feed tank, a recirculation pump, and an injection metering pump. 250 grams of the lignin additive was thoroughly blended with 2,500 grams of the feedstock and placed in the feed tank of the additive system at about 177 degrees Celsius (350 degrees Fahrenheit). This additive blend was injected into the delayed coking drum at an injection point a few centimeters below the base of the coke drum. Mass flow rates were based on 90 percent of the feed from the main feed tank without the additive and 10 percent of the additive laden feed from the additive system. The concentration of additive into the coke drum was 1 weight percent. The results from Example 1 were:

hydrocarbon gases=9.4 weight percent;

hydrocarbon liquids 57.5 weight percent;

coke=33.1 weight percent;

coke morphology=predominantly sponge coke;

gasoline=17 weight percent of the hydrocarbon liquids;

diesel=31 weight percent of the hydrocarbon liquids; and

gas oil=52 weight percent of the hydrocarbon liquids.

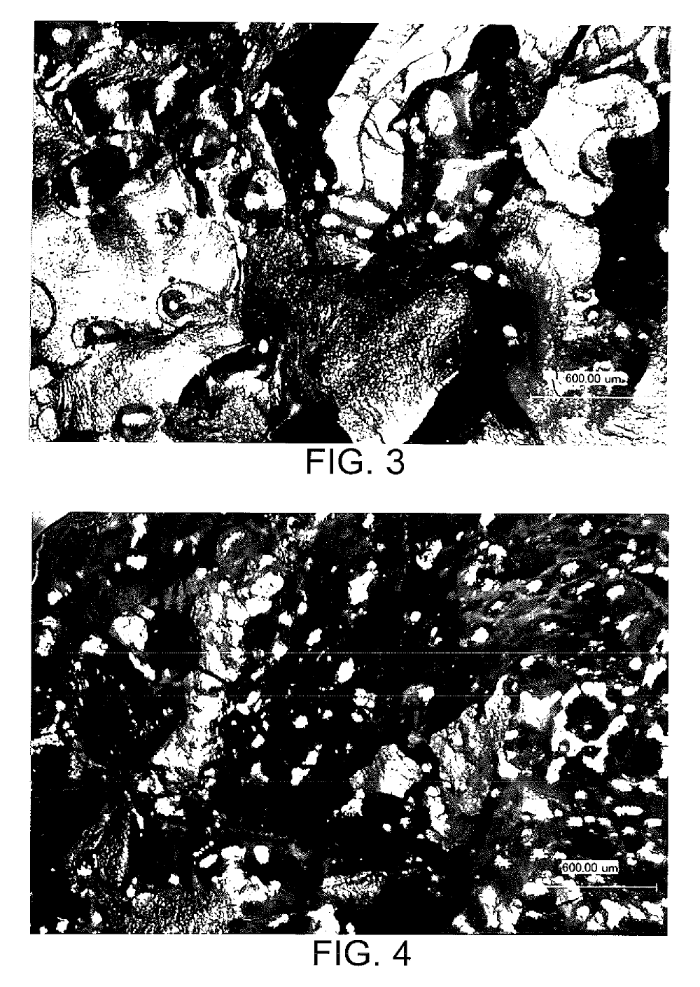

FIG. 3 shows a photomicrograph of sponge coke of Example 1, according to one embodiment. The sponge coke is generally porous and has a monolithic structure.

### Comparative Example 1

The feedstock and coking pilot unit of Example 1 were prepared as above for Example 1, but without the lignin additive or the asphaltene dispersant. Comparative Example 1 represents the average of two runs. The results from Comparative Example 1 were:

hydrocarbon gases=10.2 weight percent;

hydrocarbon liquids=56.5 weight percent;

coke=33.3 weight percent;

coke morphology=bonded shot coke;

gasoline=11 weight percent of the hydrocarbon liquids;

diesel=34 weight percent of the hydrocarbon liquids; and

gas oil=55 weight percent of the hydrocarbon liquids.

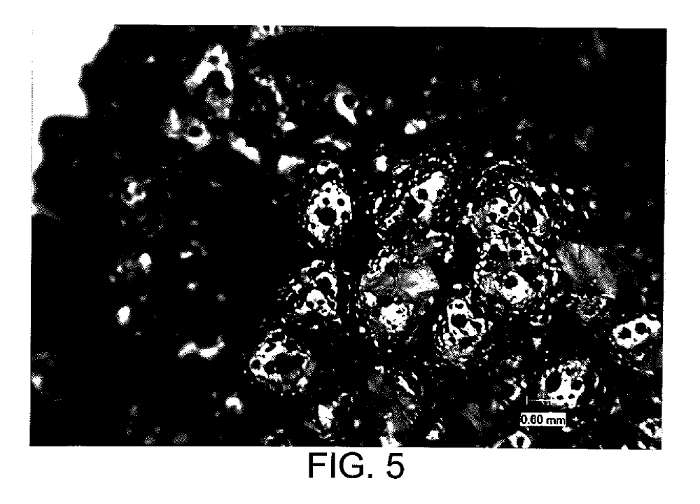

FIGS. 4 and 5 (different magnifications) show photomicrographs of shot coke of Comparative Example 1. The shot coke is generally granular (like BBs or small pellets) and lacks a monolithic structure.

### Example 2

Feedstock for Example 2 was a blend of two components including vacuum residue from Iraqi light crude blend at 80 volume percent and vacuum residue from Ecuadorian crude oil at 20 volume percent. Water was not blended with the feedstock. An additive used for Example 2 was an oxidized lignin sample obtained from MeadWestvaco Corporation, Glen Allen, Va., U.S.A. The additive had:

pH=10.7 at 15 weight percent solids concentration in water;

molecular weight=18,800 atomic mass units;

sulfur=1.6 weight percent; and

sodium sulfate=1.9 weight percent.

The additive for Example 2 was used at a concentration of 0.5 weight percent of the feedstock. 125 grams of the lignin additive was thoroughly blended with 2,500 grams of coker feed and this mixture was placed in the feed tank of the additive system at about 177 degrees Celsius (350 degrees Fahrenheit). The additive blend was injected into the delayed coking drum at an injection point a few centimeters below the base of the coke drum. Mass flow rates were based on 90 percent of the feed from the main feed tank without the additive and 10 percent of the additive laden feed from the additive system. The concentration of additive into the coke drum was 0.5 weight percent. The delayed coking pilot unit process conditions for Example 2 were

coke drum pressure=3.1 bar gauge;

furnace outlet temperature=482 degrees Celsius;

feed rate=3,600 grams per hour; and

approximately 40 grams/hour of steam was injected into the furnace tube continuously to minimize fouling.

The results from Example 2 were:

hydrocarbon gases=9.6 weight percent;

hydrocarbon liquids 63.9 weight percent;

coke=26.5 weight percent;

coke morphology=predominantly sponge coke;

gasoline=21 weight percent of the hydrocarbon liquids;

diesel 35 weight percent of the hydrocarbon liquids; and

gas oil=44 weight percent of the hydrocarbon liquids.

### Comparative Example 2

The feedstock and coking pilot unit of Example 2 were prepared as above for Example 2, but without the lignin additive. Comparative Example 2 represents the average of two runs. The results from Comparative

### Example 2 were

hydrocarbon gases=10.2 weight percent;

hydrocarbon liquids=63.2 weight percent;

coke=26.6 weight percent;

coke morphology=bonded shot coke;

gasoline=17 weight percent of the hydrocarbon liquids;

diesel=36 weight percent of the hydrocarbon liquids; and

gas oil=47 weight percent of the hydrocarbon liquids.

### Example 3

The feedstock for Example 3 was a delayed coker vacuum residue feedstock obtained from a large Midwest refinery in the United States. A feed was vacuum residue with a Micro Carbon Residue (according to ASTM D4530 (American Society for Testing and Materials, West Conshohocken, Pa., U.S.A.)) content of 24.3 weight percent and a heptane insoluble asphaltene (according to ASTM D3279) content of 14.3 weight percent.

The entire contents and teachings of ASTM D4530 and ASTM D3279 are hereby incorporated by reference in their entirety into this specification. Water was not blended with the feed. An additive of Example 3 was the same additive as Example 2.

The additive for Example 3 was used at a concentration of 0.5 weight percent of the feed. 62.5 grams of the lignin additive was thoroughly blended with 1,250 grams of coker feed. The blend or mixture was placed in a feed tank of the additive system at about 177 degrees Celsius (350 degrees Fahrenheit). The additive blend was injected into the delayed coking drum at an injection point a few centimeters below the base of the coke drum. Mass flow rates were based on 95 percent of the feed from the main feed tank without the additive and 5 percent of the additive laden feed from the additive system. The concentration of additive into the coke drum was 0.5 weight percent. The delayed coking pilot unit process conditions for Example 3 were:

coke drum pressure=2.7 bar gauge;

furnace outlet temperature=493 degrees Celsius;

feed rate=3,600 grams per hour; and

approximately 40 grams/hour of steam was injected into the furnace tube continuously to minimize fouling.

The results from Example 3 were:

hydrocarbon gases 10.6 weight percent;

hydrocarbon liquids 62.8 weight percent;

coke=26.6 weight percent;

coke morphology=predominantly sponge coke;

gasoline=19 weight percent of the hydrocarbon liquids;

diesel=37 weight percent of the hydrocarbon liquids; and

gas oil=44 weight percent of the hydrocarbon liquids.

### Comparative Example 3A

The feedstock and coking pilot unit of Example 3 were prepared as above for Example 3, but without the lignin additive. The results from Comparative Example 3A were:

hydrocarbon gases=10.8 weight percent;

hydrocarbon liquids=60.8 weight percent;

coke=29.2 weight percent;

coke morphology=predominantly sponge coke;

gasoline=22 weight percent of the hydrocarbon liquids;

diesel=32 weight percent of the hydrocarbon liquids; and

gas oil=46 weight percent of the hydrocarbon liquids.

### Comparative Example 3B

For Comparative Example 3B, the steps of Example 3A were repeated in an identical manner in all respects except that in this case 90 weight percent of the feed was injected from the main feed tank and 10 weight percent of the feed which does not contain any additive was injected from the additive system. The results obtained were found to be essentially same as those from Comparative Example 3A.

### Discussion of Examples and Comparative Examples

The example results versus the comparative example results demonstrate an effective shift in coke morphology from shot coke to sponge coke. The results also demonstrate the lignin additives increase a liquid yield, reduce a gas oil yield, and increase a gasoline yield.

As used herein the terms “having”, “comprising”, and “including” are open and inclusive expressions. Alternately, the term “consisting” is a closed and exclusive expression. Should any ambiguity exist in construing any term in the claims or the specification, the intent of the drafter is toward open and inclusive expressions.

Regarding an order, number, sequence, and/or limit of repetition for steps in a method or process, the drafter intends no implied order, number, sequence and/or limit of repetition for the steps to the scope of the invention, unless explicitly provided.

Regarding ranges, ranges are to be construed as including all points between the upper and lower values, such as to provide support for all possible ranges contained between the upper and lower values including ranges with no upper bound and/or lower bound.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A hydrocarbon conversion process additive for thermal processes, catalytic processes, or thermal-catalytic processes, the additive comprising lignin or macromolecular substructures of lignin comprising para-coumaryl alcohol, coniferyl alcohol, or sinapyl alcohol.

2. The additive of claim 1, wherein the lignin comprises an average molecular weight of between about 300 atomic mass units to about 1,000,000 atomic mass units.

3. The additive of claim 1, wherein the lignin comprises at least one of kraft lignin, klason lignin, acid-soluble lignin, acid-insoluble lignin, hardwood lignin, softwood lignin, paper pulping lignin, pyrolytic lignin, steam exploded, agricultural material lignin, genetically-modified lignin, oxidized lignin, derivatized lignin, or modified lignin.

4. The additive of claim 1, wherein the lignin comprises polyphenolic material.

5. The process of claim 1 where the hydrocarbon conversion process comprises delayed coking, continuous coking, fluidized catalytic cracking, residue fluidized catalytic cracking, thermal cracking, thermal catalytic cracking, hydrocracking, visbreaking, hydrovisbreaking, catalytic hydrovisbreaking, or coal liquefaction.

6. The process of claim 1, wherein the hydrocarbon process reduces a molecular size or average molecular weight of a feedstock.

7. A petroleum coke made with the additive of claim 1.

8. The petroleum coke of claim 7, wherein the petroleum coke comprises sponge coke.

9. A process for upgrading a heavy hydrocarbon material and making sponge coke, the process comprising:
delivering an additive to a process feedstock or into a process; and
conducting a hydrocarbon upgrading process.

10. The process of claim 9, further comprising adding an asphaltene dispersant as a coadditive.

11. The process of claim 9, wherein the additive comprises lignin or macromolecular substructures of lignin comprising para-coumaryl alcohol, coniferyl alcohol, or sinapyl alcohol.

12. The process of claim 9, wherein the additive comprises between about 10 parts per million on a mass basis and about 50,000 parts per million on a mass basis in a feedstock.

13. The process of claim 9, wherein delivering the additive with the process feedstock or into the process occurs before or after entering a furnace coil, mixing occurs at an entrance of a coke drum, or the additive is delivered to the process from a top of a coke drum.

14. The process of claim 9, wherein the process occurs in a delayed coking unit.

15. The process of claim 14, wherein the process produces petroleum coke comprising at least about 60 percent sponge coke on a mass basis.

16. The process of claim 14, wherein the additive enhances a liquid product yield, lowers a coke yield, changes a coke product morphology, or increases API gravity of a liquid product.

17. The process of claim 9, where process includes steam or water injection.

18. A petroleum coke made by the process of claim 9.

19. A refining process comprising:
mixing a lignin based additive with a hydrocarbon stream; and
thermally processing, chemically processing, or thermal-catalytically processing the hydrocarbon stream.

20. The process of claim 19, wherein the process occurs in a fluidized catalytic cracker, a residue fluidized catalytic cracker, a thermal catalytic cracker, a visbreaker, a hydrocracker, a residue hydrocracker, a coal liquefaction unit, a delayed coker, or a continuous coker.
